(19) United States
(12) Patent Application Publication
(10) Pub. No.: US 2005/0234740 A1
(43) Pub. Date: Oct. 20, 2005

(54) Business methods and systems for providing healthcare management and decision support services using structured clinical information extracted from healthcare provider data

(76) Inventors: Sriram Krishnan, Exton, PA (US); R. Bharat Rao, Berwyn, PA (US); William A. Landi, Devon, PA (US); Sathyakama Sandilya, Fontainebleau (FR)

Correspondence Address: Siemens Corporation;Intellectual Property Department, 170 Wood Avenue South, Iselin, NJ, 08830, US

(21) Appl. No.: 10/877,127

(22) Filed: Jun. 25, 2004

Related U.S. Application Data
(60) Provisional application No. 60/482,281, filed on Jun. 25, 2003.

(51) Int. Cl. G06F 17/60

(52) U.S. Cl. 705/2; 705/11

(57) ABSTRACT

Business methods and systems that are provided use knowledge-based expert systems for mining (extracting) highly structured clinical information from various structured and unstructured sources of healthcare provider data. In one business method for on-line healthcare management and decision support, a service provider maintaining a collection of structured clinical data, the structured clinical data comprising information automatically mined from various structured and unstructured sources of healthcare provider data from one or more different healthcare providers. The service provider provides a customer on-line access to structured clinical data in the collection, or providing an on-line service to the customer using structured clinical data in the collection, based on a service agreement between the customer and the service provider.

### CROSS-REFERENCE TO RELATED APPLICATION

This application claims priority to U.S. Provisional Application Ser. No. 60/482,281, filed on Jun. 25, 2004, which is fully incorporated herein by reference.

### TECHNICAL FIELD OF THE INVENTION

The present invention generally relates to medical information processing systems and methods for providing healthcare management and decision support services using clinical knowledge extracted from various structured and unstructured sources of healthcare provider data. More specifically, the present invention relates to on-line business methods and systems that implement knowledge-based expert systems for mining (extracting) structured clinical information from various structured and unstructured sources of healthcare provider data and for analyzing such structured clinical information to provide various healthcare management and decision support services.

### BACKGROUND

Due to continued technological advancements in data storage systems and information processing systems, health care providers and organizations continue to migrate toward environments where most aspects of patient care management are automated, making it easier to collect and analyze patient information. Consequently, health care providers and organizations, etc., tend to accumulate vast stores of patient information, such as financial and clinical information, in electronic patient medical records. These vast stores of electronic patient medical records typically contain a significant amount of clinical information that can be extracted and analyzed retrospectively for purposes of healthcare management and decision support including, for example, outcomes analysis or process analysis, assessing health care quality or performance, assessing conformity to accepted treatment guidelines, and/or planning and making budgeting decisions, etc.

However, electronic medical records for patients typically contained patient information that is recorded in a myriad of different structured formats (e.g., clinical, financial, laboratory databases) and unstructured formats (e.g., free text reports, dictations, image data and waveforms, genomics and proteomics, etc.), and with varying degrees of reliability, making it difficult to extract and analyze clinical information for healthcare management and decision support. Conventionally, extracting clinical information from patient medical records is performed manually, which is usually time consuming, expensive, inefficient, unreliable, and error prone.

Moreover, extracting and analyzing relevant clinical data from various structured and unstructured sources of patient information in a set of patient medical records can be difficult for various reasons. For instance, patient medical records typically contain missing, incorrect, and/or inconsistent clinical information, where key outcomes and variables may not be recorded. Moreover, there may be some bias in the data collection (e.g., sick patients get more tests than well ones) that can negatively skew a clinical data analysis. Moreover, due to the wide variation in practice, the results of clinical data analysis cannot provide a standardized measure or assessment for healthcare management and decision support (e.g., it can be difficult to determine if a patient treatment conforms to some standard guideline, or it meets basic standards of care as prescribed by organizations such as JCAHO).

### SUMMARY OF THE INVENTION

In consideration of the significant amount of legacy patient data that is currently available in electronic patient medical records, which could be of use in healthcare management and decision support, the present invention offers solutions for efficiently extracting high-quality patient information (clinical and/or financial) from various structured and unstructured sources of patient information within patient medical records, and developing applications for exploiting the use of such data.

In general, exemplary embodiments of the invention as described herein include medical information processing systems and methods for providing automated healthcare management and support services using high-quality clinical knowledge that is extracted from various structured and unstructured sources of patient information within patient medical records. More specifically, exemplary embodiments further include on-line business methods and systems that use knowledge-based expert systems for mining (extracting) highly structured clinical information from various structured and unstructured sources of healthcare provider data and analyzing such structured clinical information to provide various healthcare management and support services pursuant to one or more types of business models for collecting and processing clinical data from various healthcare providers and exploiting such structured clinical data to provide one or more commercial medical services including for example, healthcare provider management, disease management, and healthcare provider benchmarking and consulting.

For example, in one exemplary embodiment of the invention, a business method for providing on-line healthcare management and decision support services includes a service provider maintaining a collection of structured clinical data, the structured clinical data comprising information automatically mined from various structured and unstructured sources of healthcare provider data from one or more different healthcare providers. The service provider provides a customer on-line access to structured clinical data in the collection, or providing an on-line service to the customer using structured clinical data in the collection, or providing reports compiled from the data, based on a service agreement between the customer and the service provider. The structured clinical data can be updated continuously or periodically (e.g. quarterly).

These and other exemplary embodiments, aspects, features and advantages of the present invention will become apparent from the following detailed description of exemplary embodiments, which is to be read in connection with the accompanying drawings.

### BRIEF DESCRIPTION OF THE DRAWINGS

FIG. 1 illustrates a high-level schematic diagram of a system for providing automated healthcare management and decision support services using structured clinical information extracted from a collection of healthcare provider data from various healthcare providers, according to an exemplary embodiment of the invention.

FIG. 2 is a high-level flow diagram illustrating a method for providing automated healthcare management and decision support using structured clinical information extracted from a collection of healthcare provider data from various healthcare providers, according to an exemplary embodiment of the invention.

FIG. 3 schematically illustrates an exemplary knowledge-based expert system, which can be implemented for automatically extracting structured clinical information from computerized patient records containing various sources of structured and unstructured sources of patient data.

### DETAILED DESCRIPTION OF EXEMPLARY EMBODIMENTS

In general, exemplary embodiments of the invention include medical information processing systems and methods that provide automated healthcare management and support services using high-quality clinical knowledge extracted from various structured and unstructured sources of patient information within legacy patient medical records. For instance, exemplary systems and methods as described herein include knowledge-based expert systems that can automatically analyze patient information contained within legacy computerized patient records (CPRs) in structured and unstructured formats to extract high-quality clinical information that is stored in a structured format. Note that the high-quality clinical information that is stored in a structured format, also called structured clinical data, can include references or links to the original patient data, including unstructured data sources.

Moreover, as described below, various e-business methods and on-line systems can be developed based on such structured clinical information, whereby a trusted service provider can collect and process legacy patient information from various healthcare providers and commercially exploit such structured clinical data to provide one or more commercial medical services including for example, healthcare provider management, disease management, and healthcare provider benchmarking and consulting. Here, healthcare providers is included to mean any person or organization set up to provide healthcare to individuals, including but not limited to hospitals, physician practices, private physicians, healthcare networks, assisted living facilities, home health agencies, and nursing facilities, and subsets or groups thereof.

It is to be understood that the systems and methods described herein in accordance with the present invention may be implemented in various forms of hardware, software, firmware, special purpose processors, or a combination thereof. In one exemplary embodiment of the invention, the systems and methods described herein are implemented in software as an application comprising program instructions that are tangibly embodied on one or more program storage devices (e.g., hard disk, magnetic floppy disk, RAM, CD Rom, DVD, ROM and flash memory), and executable by any device or machine comprising suitable architecture.

Note that any part of this process can also be carried out in a non-automated manner e.g., patient data may be exported by a healthcare provider, and sent to a data mining service provider on CDs.

It is to be further understood that because the constituent system modules and method steps depicted in the accompanying Figures can be implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

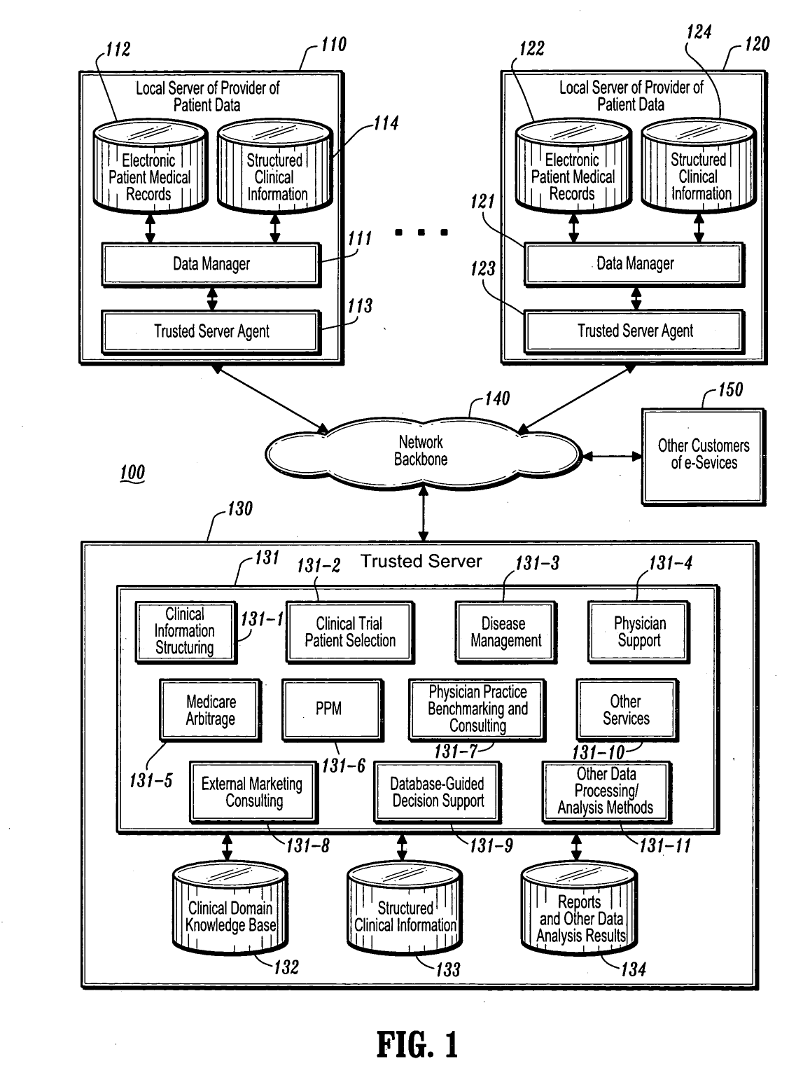

FIG. 1 is high-level schematic diagram that illustrates a system (100) for providing automated healthcare management and decision support services using structured clinical information extracted from a collection of healthcare provider data from various healthcare providers, according to an exemplary embodiment of the invention. More specifically, FIG. 1 illustrates a business model for providing on-line healthcare management and decision support services according to an exemplary embodiment of the invention, wherein various types of service requestors (customers) can access one or more applications for automated healthcare management and decision support services, which are offered by an application service provider (ASP), based on service agreements, usage contracts, etc., between the application service provider and the customers.

Referring to FIG. 1, In general, the system (100) comprises a plurality of computing systems (110) and (120) that are operated at clinical sites of different healthcare providers (including, but not limited to, physicians, hospitals, or other healthcare organizations, institutions, or associations, etc.). The computing systems (110) and (120) comprise respective data management systems (111) and (121) for managing respective repositories (112) and (122) of healthcare provider data (e.g., computerized patient medical records containing patient information recorded in various structured and unstructured formats). The computing systems (110) and (120) may be server computers within local networks at the respective provider sites, which include server applications that provide access to patient medical records (112), (122), for example.

Note that the business model supports starting with a few (even one) healthcare providers and then expanding the service to many providers.

The system (100) further comprises a trusted server system (130) operated by a trusted application service provider, which can be accessed over a communications network (140) by various healthcare providers and other customers (insurance companies, medical device or drug manufactures, etc) to obtain on-line healthcare management or decision support services offered by the application service provider. In general, the trusted server system (130) comprises an application server (131) which provides on-line access to a set of applications (131-1, 131-2, . . . 131-10) for automated healthcare management and decision support services, a clinical domain knowledge base (132), a central repository (133) for persistent storage of structured clinical information, and a repository (134) for persistent/temporary storage of reports or other data analysis results.

More specifically, the application server (131) provides business logic for various automated (or semi-automated) healthcare management and decision support services, including, clinical information structuring (131-2), clinical trial patient selection (131-2), disease management (131-3), physician decision support (131-4), Medicare arbitrage (131-5), PPM (healthcare provider management) (131-6), healthcare provider benchmarking and consulting (131-7), external marketing consulting (131-8), database-guided decision support (131-9), and other medical services (131-10) and data processing/analysis methods (131-11), all of which will be explained in further detail below.

Healthcare data (unstructured or structured patient data) is collected or otherwise obtained from either one or a plurality of different healthcare providers. The clinical information structuring application (131-1) then generates a large centralized database of structured clinical information stored in repository (133). This repository can exist in one central location, or it can be distributed over a number of different locations, or can exist at the location of each healthcare institution. For example, the healthcare provider data in repositories (112), (122) can be provided to the trusted server (130) for generating structured clinical information to be maintained in the central repository (133). The structured clinical information stored in the central repository (133) can be “de-identified” (as explained below) for applications in which patient privacy is required for sharing patient data between various entities.

Moreover, the clinical information structuring application (131-1) can be accessed by a healthcare provider to extract clinical information from a local repository of patient medical records at the provider site. One form of access may simply be providing the healthcare provider with periodic reports compiled from the data. Alternatively, the healthcare provider can access the data “on-line”, which would allow the healthcare provider to access the data in an interactive fashion. This could either be done by accessing the data over a network through some application, or periodically providing the healthcare provider with the data and access application, perhaps on CDs or DVDs, so that they may install it locally on a machine and interact with the structured clinical data.

For instance, as depicted in FIG. 1, the computing systems (110), (120) may include respective local repositories (114), (124) of structured clinical information. For this purpose, the trusted server (130) may provide a trusted server agent (113), (123) to respective computing systems (110), (120), which comprise executable code for locally processing the electronic patient medical records (112), (122), to generate structured clinical information (114), (124). The structured clinical data extracted from healthcare provider data of a given healthcare provider can be stored either locally or remotely.

The various applications (131-2˜131-11) implement methods for analyzing the structured clinical information in the central repository (133) (and/or possibly locally stored structured clinical information at a provider site) to provide various healthcare management or decision support services as discussed below. In general, some or all of the applications supported by application server (131) may be implemented as knowledge-based expert systems that analyze structured clinical information using relevant knowledge in the clinical domain knowledgebase (132) (which includes various trained classification models, parameters, rules and/or other data structures of learned knowledge, etc, for one or more clinical domains). This knowledge base can be built incrementally beginning with a small amount of knowledge on issues of high value for a single disease, and eventually growing as needed to deal with a large number of issues for multiple diseases. For example, in cardiology it is known that heart failure is one of the most expensive diseases to treat in terms of resources spent. One could envision a system which starts by addressing heart failure, and then expands to include other cardiac diseases, such as ischemia or valvular disease. In addition, the service provider can update the domain knowledge continuously to deal with changing practice guidelines, new clinical trials etc. Note that this will change the structured data that is produced by the data mining system. The new knowledge may be used both to analyze data for new patients, and to rerun the analysis for old patients.

It is to be understood that although a client-server framework is depicted FIG. 1, the system (100) may be implemented using any suitable computing environment framework such as P2P (peer-to-peer) or master/slave, for example. The network (140) may comprise any suitable network configuration such as an Intranet, a LAN (local area network), WAN (wide area network), P2P, a global computer network (e.g., Internet), a wireless communications network, a virtual private network (VPN), etc. Further, while the illustrative embodiment of FIG. 1 illustrates a single server (130), those skilled in the art will understand that the various applications (131) and/or repositories (132), (133) and (134) may be distributed over the network (140) on different host machines. Those of ordinary skill in the art can readily envision various architectures for implementing a system 100 according to the invention based on the teachings herein and nothing herein shall be construed as a limitation of the scope of the invention.

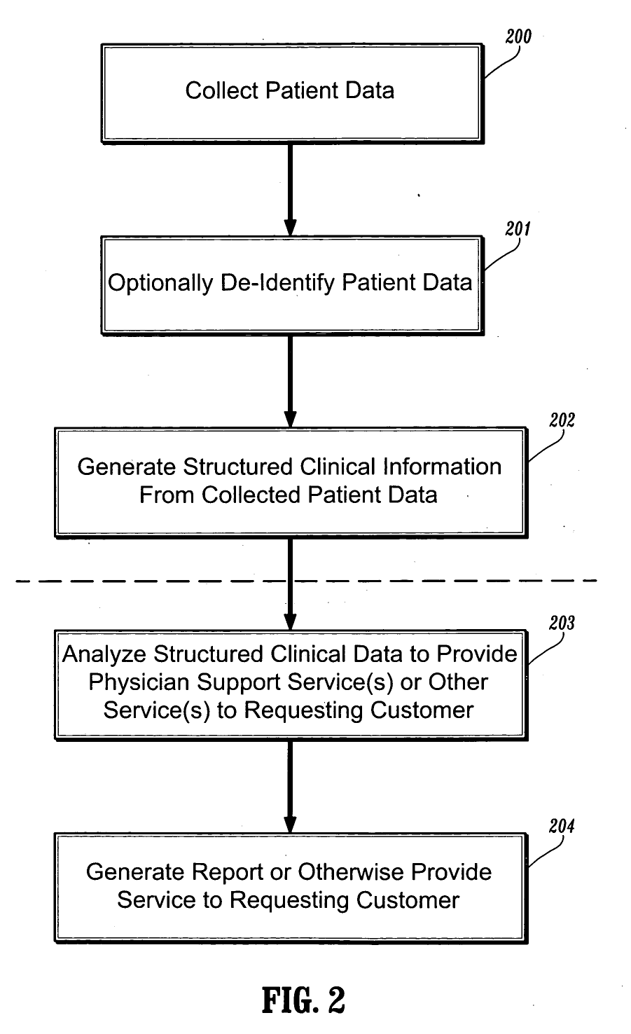

FIG. 2 is a high-level flow diagram illustrating a method for processing healthcare provider data according to an exemplary embodiment of the invention. It is to be understood that the flow diagram of FIG. 2 illustrates methods steps that can be implemented for one of various exemplary embodiments of the invention for processing healthcare provider data. For example, in one exemplary embodiment, the method of FIG. 2 illustrates one or more modes of operation of the system of FIG. 1. Other exemplary methods for processing and commercializing healthcare provider data will be discussed with reference to FIG. 2.

Referring now to FIG. 2, initially, medical data (healthcare provider data) is collected from one or more different healthcare organizations (or data providers) in one or more clinical domains e.g., cardiology, oncology, etc.) (step 200). The medical data may be obtained from a variety of different structured and/or unstructured data sources that are typically maintained at clinical sites. For example, as depicted in FIG. 1, patient medical records (112), (122) that are stored at various clinical sites typically include a plurality of structured and unstructured source of patient data collected over the course of patient treatments. The patient information may include, e.g., computed tomography (CT) images, X-ray images, laboratory test results, doctor progress notes, details about medical procedures, prescription drug information, radiological reports, other specialist reports, demographic information, billing (financial) information, and genomic and proteomic data. In general, the structured data sources include, for example, financial databases, laboratory databases, and pharmacy databases, wherein patient information in typically maintained in database tables. The unstructured data sources include for example, free-text based documents (e.g., physician reports, etc.), images and waveforms data, and genomic and proteomic data.

It is to be appreciated that the process of collecting healthcare provider data (step 200) can be performed in various manners, depending on the given application. For instance, in one exemplary embodiment such as depicted in FIG. 1 wherein the healthcare provider data is collected, processed and maintained at a central location (trusted server (130), the healthcare provider data can be sent to the central location from one or more healthcare providers. For example, the data could be collected and recorded on a storage media, such as CDs or DVDs, and sent to the central location for processing. Alternatively, the data could be securely transmitted over a communication network (140) such as a wide-area network or Internet (using a VPN or other technology to secure the transmission) to the central location for processing.

After collecting the healthcare provider data, an optional process of “de-identifying” the patient data (step 201) can be performed for applications in which there are ethical and legal responsibilities for protecting patient privacy. In particular, there may be instances in which organizations cannot release or otherwise disclose patient data records that contain patient identifying information that can be used to identify patients without patient approval unless there is a valid reason as defined by various laws and regulations. For example, in the United States, the “Privacy Rule” of the HIPAA (Health Insurance Portability and Accountability Act) provides Federal privacy regulations that set forth requirements for confidentiality and privacy policies and procedures, consents, authorizations and notices, which must be adopted in order to maintain, use, or disclose individually identifiable health information in treatment, business operations or other activities. The HIPAA Privacy Rule allows for certain entities to “de-identify” protected health information for certain purposes so that such information may be used and disclosed more freely, without being subject to the protections afforded by the Privacy Rule. The term “de-identified data” as used by HIPAA refers to patient data from which all information that could reasonably be used to identify the patient has been removed (e.g., removing name, address, social security numbers, etc. . . . ). The Privacy Rule requirements do not apply to information that has been de-identified.

The de-identification process (step 201) may be implemented using one or more methods including manual or automated methods. For instance, a manual method for de-identifying patient data includes manually stripping all information from the patient data records that can be used to determine the identity of a patient, or replacing such patient identifying information with something else (e.g. replace the actual name with the string “name”). With such methods, although the patient data records are de-identified, there is no mechanism by which patient identification can be recovered, if necessary.

If the healthcare provider has a business associate agreement with the service provider, then it is possible to work with identified patient data, thus simplifying the process.

In another exemplary embodiment of the invention, the de-identification process (step 201) may be implemented using the methods described in U.S. patent application Ser. No. 10/796,255, filed on Mar. 9, 2004, entitled: “Systems and Methods For Encryption-Based De-Identification of Protected Health Information”, which is commonly assigned and fully incorporated herein by reference. This application describes methods for using secured encryption to enable de-identification of patient data in a manner that protects patient privacy, while allowing owners of the patient data and/or legally empowered entities, to re-identify subject patients that are associated with de-identified patient data records, when needed or desired. More specifically, a de-identification method includes manually and/or automatically removing patient identifying information from data records of one or more individuals to generate a de-identified data records, generating an encrypted ID for each individual, wherein the encrypted ID comprises an encrypted representation of one or more items of individual identifying information, and storing the encrypted ID with or in the de-identified data record. A decryption key is securely maintained and accessible by an authorized entity that is legally authorized or empowered to decrypt the encrypted ID in the de-identified data record to re-identify the individual. These methods for de-identifying/re-identifying patient data can be implemented for various purposes such as research, public health or healthcare operations, while maintaining compliance with regulations based on HIPAA for protecting patient privacy.

After the healthcare provider data is collected (step 200) and optionally de-identified (step 201), the patient data will be processed to extract relevant patient information, which is used for producing structured clinical information (including clinical and financial information) (step 202). In one exemplary embodiment of the invention, such as depicted in FIG. 1 wherein the healthcare provider data is collected and remotely processed and maintained by the trusted server (130), the clinical information structuring method (131-1) can be invoked to process the collected de-identified healthcare provider to generate structured clinical information, which is stored in the central repository (133). In another embodiment, a clinical information structuring method may be locally executed at the site of the healthcare provider to generated structured clinical information (114), (124) from the local patient medical records (112), (122). This may be achieved using known agent methods that allows the trusted server (130) to provide duplicate executable code for transmission over the network (140) to a local computing system (110), (120) in the form of a trusted server agent (113), (123) that can provide methods for clinical information structuring at the healthcare provider site. In this case, the data is stored locally, and sent to the system via a local network. The structured data could either be stored on a central location or local to the practice.

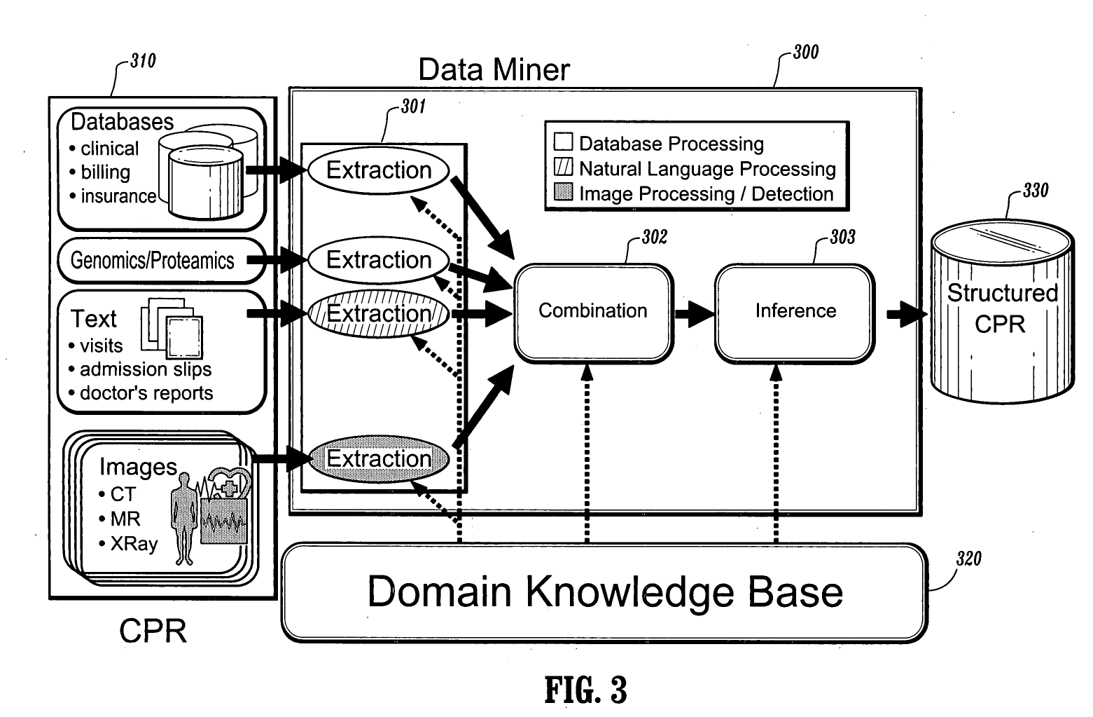

It is to be appreciated that any suitable method may be used for implementing the process (step 202) of generating structured clinical information from collected healthcare provider data. It is to be appreciated than any suitable data analysis/data mining technique may be implemented for the process (step 202) of generating structured clinical information from collected healthcare provider data. In one exemplary embodiment of the invention, a method for clinical information structuring is implemented using systems and methods described in commonly assigned and copending U.S. patent application Ser. No. 10/287,055, filed on Nov. 4, 2002, entitled “Patient Data Mining”, which claims priority to U.S. Provisional Application Ser. No. 60/335,542, filed on Nov. 2, 2001, which are both fully incorporated herein by reference. Details regarding such systems and methods will be discussed below with reference to FIG. 3, which illustrates a system and method for extracting and analyzing patient information included in an electronic medical record, as disclosed in the above-incorporated application.

The above process (e.g., steps 200-202) essentially comprises on “off-line” method as part of a service offered by a service provider for collecting and processing healthcare provider data from various organizations. For example, several hospitals may participate in the service to have their patient information mined, and this information may be stored in a data warehouse (133) owned by the service provider in the form of structured high-quality clinical data.

The structured clinical data can be exploited for one or more commercial uses, by developing applications that can analyze the structured clinical information (133) to provide various healthcare management and decisions support services or other functions (step 203), examples of which will be described below. Such services can be offered to various customers based on use or service agreements with the service provider, which enable customers to obtain “on-line” services and obtain reports or results according to the requested service(s) (step 204). As noted above, the structured clinical data could be stored centrally and/or locally. When structured clinical data is stored locally at the site of a healthcare provider, such structured clinical data can be made “virtually central” by using methods for sharing files between networked machines. Such file sharing would not be allowable between different healthcare providers, but instead be used to allow the central trusted service provider to access locally stored structured clinical data at one or more local sites for providing healthcare management and decision support services (e.g., benchmarking) requiring access and analysis of data from various different healthcare providers.

Similarly, processing results can be sent back to a customer in a number of ways. A periodic report can be sent to the customer. The physician may be able to access the structured data, either through an Internet or other remote connection (in the case where the data is processed remotely), or locally (if the data is processed locally). This access could be as simple as requesting a predefined report or as complex as allowing the user to generate ad hoc reports with arbitrary structure e.g., the equivalent of full SQL database queries. In the case of patient identification for clinical trials, a physician may get a report any time a new trial is underway, while the trial sponsor may get aggregated information. In addition, the data could be mined for knowledge to help answer clinical questions. For example, one can discern trends in the data that suggest which treatment should be used for a particular patient. Such information could be combined with knowledge obtained from a physician or other source to help answer these questions. The structured patient information (possibly with links to the original patient data) may be retrieved interactively by the customer, or sent to them on a periodic basis on media such as CD for decision support.

As noted above, in one exemplary embodiment of the invention, the clinical information structuring application (131-1) is implemented using the systems and methods described in U.S. patent application Ser. No. 10/287,055. In general, FIG. 3 illustrates a system and method for analyzing various sources of structured and unstructured patient information included in electronic medical records to extract high-quality clinical information that in a structured format (330).

More specifically, FIG. 3 illustrates a data mining system comprising a data miner (300) that extracts information from a CPR (computerized patient record) (310), which contains various structured and unstructured source of patient information, using domain-specific knowledge contained in a knowledge base (320). The data miner (300) includes various modules/components for extracting information from the CPR (310), combining all available evidence in a principled fashion over time, and drawing inferences from such combination process. In particular, an extraction module (301) includes methods for extracting small pieces of information from each of a plurality of data sources (database, text, images) of patient data within the CPR (310), which are represented as probabilistic assertions about the patient at a particular time. These probabilistic assertions are called elements. A combination module (302) combines all the elements that refer to the same variable (domain-specific criteria) at the same time period to form a single unified probabilistic assertion regarding that variable. These unified probabilistic assertions are called factoids. An inference module (303) analyzes the factoids, at the same point in time and/or at different points in time, to produce a coherent and concise picture of the progression of the patient's state over time. This progression of the patient's state is called a state sequence. In accordance with the present invention, the inference module (303) can determine a probability of the existence of a particular condition based on an analysis of the extracted clinical information using domain-specific criteria.

Indeed, each module (301, 302, and 303) uses detailed knowledge (domain-specific criteria) regarding the particular domain-specific condition (medical diagnosis) in question. The domain knowledge base (320) can be encoded as an input to the system, or as programs that produce information that can be understood by the system. The domain knowledge base (320) may also be learned from data. The domain-specific knowledge may include disease-specific domain knowledge. For example, the disease-specific domain knowledge may include various factors that influence risk of a disease, disease progression information, complications information, outcomes and variables related to a disease, measurements related to a disease, and policies and guidelines established by medical bodies. The domain-specific knowledge may also include institution-specific domain knowledge. For example, this may include information about the data available at a particular hospital, document structures at a hospital, policies of a hospital, guidelines of a hospital, and any variations of a hospital.

The data miner (300) of FIG. 3 can be used in the system of FIG. 1 to process healthcare provider data (on-line and off-line) from various healthcare providers to accumulate a large collection of structured clinical information, including the structured clinical data centrally and locally stored in repositories (133), (114), (124), etc. The various applications supported by the application server (131) can access (physically, virtually) and analyze structured clinical information in the repositories (133), (114) and/or (124), etc., to provide healthcare management or decision support services. It is to be appreciated that the applications can be implemented using a knowledge-based expert system having a framework similar to the data mining framework of FIG. 3. In such instance, the data miner (300) would receive structured clinical information (structured CPRs) as input and the extraction module (301) would extract relevant clinical information using information in the domain knowledge base (320) for the associated service. Moreover, the combination and inference modules would utilize relevant knowledge in the knowledge base (320) to analyze and classify the extracted features to generate a particular output/report for the associated service. It is to be appreciated that if a knowledge-based expert system as depicted in FIG. 3 implements probabilistic reasoning for classification, the results of each structure and/or analysis may be combined with a probability or confidence of the answer.

The following discussion will provide details regarding exemplary business methods or commercial applications according to the invention, which may be implemented for exploiting a collection of structured clinical information data extracted from patient medical records of various healthcare providers. In particular, exemplary business methods for providing automated healthcare management and decision support using structured clinical information will be discussed with reference to the exemplary applications (131-1˜131-11) as noted above for the exemplary business model of FIG. 1.

Identification of Patients for Clinical Trials or Other Uses

In one exemplary embodiment of the invention, applications can be developed for analyzing a collection of structured clinical information to identify patients for various purposes, including clinical trial participation, based on some specified inclusion and/or exclusion criteria. More specifically, by way of example, a pharmaceutical company or other organization sponsoring a clinical trial would need to identify potential individuals that could participate in the clinical trial. In this regard, the use of healthcare provider information is especially advantageous because as compared to hospital patient records, healthcare provider data typically contains a significant amount of information that would be relevant for assessing a potential patient against some inclusion/exclusion criteria. For example, in one known clinical trial for a heart failure drug, potential participants were identified as those patients having received a stable dose of an ACE inhibitor for at least 3 months. Given that such inhibitors are only prescribed (and doses changed) by physicians in their office, such information could only be found by gathering data from a healthcare provider.

In the exemplary embodiment of FIG. 1, a customer (150) can access the clinical trial patient selection application (131-2) and specify some inclusion and/or exclusion criteria for a particular clinical domain, in which case the structured clinical information in the central and/or local repositories (133), (114), (124) will be accessed and analyzed to automatically identify potential patients for participation in a clinical trial (or other purposes) based on the specified inclusion/exclusion criteria. Thereafter, a report can be generated for the customer, which includes some aggregated information regarding the identified patients (e.g. Dr. Smith at Hawaii Heart Center has 7 patients that fit these criteria). The physician, or practice, could then be contacted with a list of patients that fit the particular trial.

It is to be appreciated that the clinical trial patient selection process (131-2) can implement using the methods described in U.S. patent application Ser. No. 10/287,098, filed on Nov. 4, 2002, entitled: “Patient Data Mining for Clinical Trials,” which is commonly assigned and fully incorporated herein by reference (Attorney Docket No 2002P18245US).

In another exemplary embodiment, the patient selection process (131-2) can be used for analyzing the collection of structured clinical information to determine the number of patients that meet some specified set of inclusion and exclusion criteria. For example, when formulating a clinical trial, it would be beneficial for the sponsor to be able to determine whether a particular set of criteria is too narrow (in which case patient recruitment can be difficult) or too broad (in which case the criteria could be narrowed). Indeed, once the criteria for a clinical trial are specified, it is very expensive to change the criteria during the trial. Currently, pharmaceutical companies have very limited methods for estimating a number of patients that may be eligible for a trial given a set of inclusion/exclusion criteria. Advantageously, the structured clinical information can be used for formulation of inclusion/exclusion criteria for clinical trials. Such service would allow the pharmaceuticals to determine the potential population size for a given set of criteria and identify potential problems before finalizing the criteria. This would be of significant financial benefit for these companies. The set of trials for which patients are identified can be updated periodically by automatically retrieving the list of current trials from regulatory authorities, and the knowledge required for this identification can be kept up to date.

In yet another exemplary embodiment of the invention, the structured clinical information can be used for identifying patients based on exclusion and/or inclusion criteria for other decision support applications beyond clinical trials. For example, recent changes in ACC (American College of Cardiology) standards for heart failure state that anyone with an ejection fraction of less than 30% and documented evidence of coronary artery disease should be considered as a candidate for an implantable defibrillator. Physicians often understand this, but often in the hustle of a busy practice, these things are overlooked. Furthermore, due to the increasing number of standards that are promulgated, it is hard for physicians to keep track of such standards. In this case, a physician may want to identify patients whose ejection fraction is less than 30%, have document evidence of coronary artery disease, and do not have an implantable defibrillator. Of course, one could also envision a system that could alert the physician while the patient is there (before discharge, for example) and identify standards that have not been followed.

In another exemplary embodiment of the invention, the structured clinical information can be used to identify potential patients who are not being treated according to established guidelines. In such instance, customers may include healthcare provider management entities or payers (such as insurance companies) who access such service for purposes of, e.g., preventing future complications and healthcare costs. For example, such customers may want to identify patients with documented cases of heart failure and who were not prescribed beta-blockers. Evidence suggests that these patients are highly likely to have future acute conditions, which will require expensive hospitalizations and reduce their quality of life. In one exemplary embodiment, the structured clinical information associated with a particular healthcare organization or physician group can be analyzed at the request of the healthcare provider management or to the payer based on some specified criteria. In addition, the physician could be provided notices about which of their patients are not being treated according to guidelines. Further when a new guideline is established, a report can be generated to determine all the patients under care of the healthcare provider who are eligible for treatment under the guideline. The healthcare provider can decide to contact the patients about the guidelines. This benefits the patients and creates additional revenue opportunities for the provider.

Accordingly, it can be readily appreciated that there is commercial value in identifying patients based on inclusion and/or exclusion criteria using data collected from healthcare providers. A number of different customers can be identified for this data.

Disease Management

In another exemplary embodiment of the invention, applications can be developed for analyzing a collection of structured clinical information to provide disease management services. As the cost of health care continues to skyrocket, particularly for chronic diseases, the demand for disease management continues to rise. A number of companies have employed disease management schemes that enable monitoring a patient over time, and communicating back to the patient and physician about their status. Typically, disease management programs are implemented for chronic diseases, such as heart failure or diabetes, and therefore, much of the management of the disease occurs at the physician's office. Unfortunately, current schemes do not enable disease management companies to have access to patient medical records maintained at the physician's office. Even assuming that disease management companies were provided access to patient records, it would be difficult to extract relevant patient information from such records given the fact that such patient information can be recorded in unstructured forms and in various different locations.

Therefore, in another exemplary embodiment of the invention, structured clinical information can be used for providing disease management services. More specifically, by way of example in FIG. 1, a customer can access an “on-line” service for disease management analysis (131-2) of the application server (131). The structured clinical data can be processed to extract relevant information that is presented to a disease management company to help manage a disease. In addition, a disease management company can assess whether a physician is following a set health care path for a given individual. In this case, the customer could be a disease management company, a payer of service (such as an insurance company), or even the physician or practice that may want to perform disease management on their own.

Physician/Nurse Support

Today, it is often difficult to ensure that patients are receiving the best care. In many cases, well-established guidelines, either established by the physician, practice, payer, or a governing body such as the ACC, have been developed. However, given the number of guidelines, and the number of patients that must be seen by a physician, it is easy for patients to “fall between the cracks.” For example, while it is well known that ACE inhibitors should be prescribed at discharge for heart failure patients with a left ventricular ejection fraction of less than 40%, a recent study had indicated that only 68% of such patients were actually given them.

In another exemplary embodiment of the invention, applications can be developed for analyzing structured clinical information extracted from the collection patient medical records of a particular healthcare provider to provide physician support services with regard to care management. For example, in the system of FIG. 1, a customer (e.g., physician) can access an “on-line” service for automated physician support (131-4) for determining whether a patient's medical treatment as indicated in the patient's medical record has followed clinical guideline. In general, with this service, the patient data records of the healthcare provider can be analyzed to generate structured computerized medical records of the patients comprising structured clinical information. This process can be performed in various manners. For example, the patient medical records can be analyzed off-line one time on retrospective data, or periodically on new patient data as it is generated (daily, weekly, on demand, other regular or irregular time periods, etc.). The structured clinical information can then be analyzed appropriately to determine or verify whether a give patient or patients is/are on a given treatment guideline, or what fraction of patients are on a particular guideline, etc. The structured clinical data of a given patient can be evaluated to determine if their care matches that of an established clinical guideline. Thereafter, reports in the form of notices or reminders can be sent to the physician either as a reminder of what to do next, or as a caution if a guideline appears to be violated. In other words, with this model, clinical data can be used to provide reminders to ensure that standards are being met. For example, if a heart failure patient is about to be discharged, and their LVEF<40%, and there is no record of ACE inhibitors being prescribed, a note can be sent to the physician.

Furthermore, when an existing patient returns for a visit, alerts can be generated if the patient is not being treated per guidelines. For example, it is well known to cardiologists that patients with heart failure should be taking beta-blocker medication. However, national statistics show that the percentage of heart failure patients who are actually taking beta-blockers is quite low. Part of the problem is that physicians, who are extremely busy in the current medical climate, sometimes overlook this guideline. An alert can be given to the doctor or nurse, either electronically or on a sheet of paper, informing them that the patient should be given beta-blockers. Another example would be to alert the physician or nurse that the patient should be given a diagnostic test. For example, it is known that cardiac patients who undergo revascularization should be tested each year for cardiac function, either with stress EKGs or nuclear scans. However, patients often do not receive these tests, again because of scheduling or other issues. By providing alerts, either to a physician, nurse, or a scheduler at the healthcare institution, the healthcare provider can ensure that the patient receives proper diagnostic test.

Yet another example of physician or nurse support can be illustrated for monitoring of a clinical trial. Clinical trials often require strict adherence to a set of clinical guidelines outlined in the protocol. For patients on clinical trials, analysis could be done to verify if the patient is on the protocol, and alerts issued if the patient is veering from that protocol.

Note that this allows the results of the data analysis to affect medical practice by intervening at the “point of care” (when and where the healthcare services are provided to the patient), either by providing these results to the physician in an interactive fashion, or as in the form of summary reports (at the patient or population level). This form of “on-line” physician support could support the physician to provide the best care possible for the patient.

The business model may also be extended to include revenue and/or profit sharing between the service provider and the healthcare provider for each test/medication recommendation. This revenue may be shared either only between the service provider and the healthcare provider, or possibly also with other third parties.

U.S. patent application Ser. No. 10/287,074 filed on Nov. 4, 2002 entitled “Patient Data Mining for Quality Adherence”, which is commonly assigned and fully incorporated herein by reference, describes methods that can be implemented for physician support services, such as determining whether a patient's medical treatment as indicated in the patient's medical record has followed clinical guidelines according to domain-specific criteria. In particular, U.S. patent application Ser. No. 10/287,074 describes a system and method for generating accurate quality adherence information during the course of patient treatment, which processes clinical data extracted from patient records against a guidelines knowledge base containing clinical guidelines, wherein a quality adherence engine monitors adherence with the clinical guidelines for the patients being treated based on the clinical data. The system includes an output component for outputting quality adherence information. The outputted quality adherence information may include reminders, including reminders to take clinical actions in accordance with the clinical guidelines. The outputted quality adherence information may also include warnings that the clinical guidelines have not been observed. Adherence to the clinical guidelines can be monitored by comparing clinical actions with clinical guidelines. The clinical guidelines can relate to recommended clinical actions.

Moreover, since the clinical action information may be a product of inferences, it may therefore be probabilistic in nature. Thus, the warnings may be generated if there is likelihood that the guidelines haven't been followed. Probability values may be assigned to each clinical action, and warnings issued if the probability that the guidelines weren't followed exceeds a predefined threshold. Moreover, quality adherence to clinical guidelines may be monitored by determining the next recommended clinical actions. Reminders for the next recommended clinical actions may be output so that health care personnel are better able to follow the recommendations.

In FIG. 1, the clinical guidelines are retrieved from the clinical domain knowledge base (132). For example, the clinical guidelines may be stored in database, and contain recommended clinical actions for various diseases of interest. These clinical guidelines may include recommendations promulgated by accreditation organizations (such as JCAHO), government agencies, and consumer health care organizations. In addition, clinical guidelines may be created for internal use (e.g., by a hospital to measure quality of care). In general, clinical guidelines may include any list of recommended clinical actions.

Enable Performance-Based Payments

Many healthcare payers (insurance companies), especially Medicare, are interested in reducing health care costs while maintaining patient outcomes. In particular, by way of example, Medicare has commenced pilot programs to provide “performance-based pay”. With such programs, physician groups can obtain additional payments based on their ability to reduce healthcare costs while maintaining or improving outcomes. With conventional management schemes, however, it is very difficult to document such improved performance or reduced costs.

Advantageously, by extracting and maintaining patient information in a structured clinical information format, the present invention provides mechanism for readily tracking healthcare costs and outcomes. First, outcomes can be improved, while reducing costs, simply by adhering to well known guidelines using the methods described above for monitoring adherence to guidelines to provide physician support and assistance in adhering to guidelines. Moreover, patient information can be analyzed and processed to extract structured patient information that enables electronic documentation of (i) adherence to clinical guidelines; (ii) patient outcomes, risk adjusted based on co-morbidities and demographics, (iii) and total cost to manage a patient, etc.

More specifically, in the exemplary embodiment of FIG. 1, a customer (e.g., physician) can access an “on-line” service of Medicare arbitrage (131-5) which provides methods the appropriate methods of automated monitoring and documentation as noted above to assist in tracking healthcare costs and outcomes. Therefore, combined with the ability of the system to create alerts and support adherence to guidelines (described previously), this on-line system of FIG. 1 could enable healthcare providers to participate in programs such as Medicare Arbitrage.

Healthcare Provider Management Systems (PPMS)

Currently, there is a push for healthcare providers to adopt healthcare provider management systems. The promise of such systems includes improved efficiency of healthcare delivery, and improved documentation to meet the growing demands of payers such as Medicare. However, current systems have two significant problems. First, most systems require a significant investment in IT (information technology) infrastructure, such as new machines and software. Secondly, these systems require that physicians change the way they practice, and document according to the “rules” of the PPMS they are using. Physicians are typically not amendable to changing their way of practicing medicine.

Accordingly, one exemplary embodiment of the invention as depicted in FIG. 1, an automated “on-line” PPMS application (131-6) can be developed using structured clinical information. More specifically, a physician group can have their legacy patient data records mined to populate a database having structured patient information for each patient. Then, various methods can be implemented to (i) generate reports about a patient; (ii) allow the physician to search the clinical records; (iii) generate billing and financial information about a patient; and (iv) create reminders and alerts to assist the physician in managing the patient based on guidelines (as described above).

By implementing a PPMS according to the invention, data can be collected in an unstructured format, such as transcribed physician notes, and thus a physician does not have to change his/her manner of practice. Moreover, there is no need to purchase expensive systems. As described above, the healthcare provider data could be collected and structured off-site by a service provider. The physician group can then access their structured clinical data remotely, through a Web-based interface, for example. Alternatively, the entire system could reside locally at the healthcare provider.

Healthcare Provider Benchmarking and Consulting

Another application that can be developed around structured clinical information according to the invention is benchmarking—by collecting data from a number of healthcare providers, and structuring the information, a customer could obtain automated service of benchmarking for purposes of comparing different healthcare providers. Today, benchmarking is typically performed using only financial information stored in billing databases, such as ICD-9 and CPT codes. Unfortunately, ICD-9 codes are often wrong, which could result in improper conclusions. As a result, the extent of the benchmarking based on current methods is limited.

In another exemplary embodiment of the invention, applications can be developed for analyzing structured clinical information extracted from the collection patient medical records of many different healthcare providers to provide methods for benchmarking and consulting. For example, in the system of FIG. 1, a customer can access an “on-line” service for automated benchmarking and consulting (131-7) for obtaining various related services. For instance, one method enables automated risk-adjustment analysis based on clinical information and comparison of patient outcomes. Another example is guideline compliance to determine, e.g., how well a given healthcare provider complies with a particular guideline as compared to other providers/practices. Such information could also be used to provide consulting services to the physician groups.

Benchmarking comprising measuring performance of a healthcare provider against other healthcare providers or against an accepted standard.

In yet another embodiment, automated methods can be implemented for providing automated documentation for internal and external purposes. By way of example, methods can be implemented for automated monitoring of adherence to performance measures for Joint Commission on Accreditation of Healthcare Organizations (JCAHO) JCAHO accreditation (e.g. was aspirin given within 24 hours of myocardial infarction) Alternatively, the system could be used by an accrediting agency to review JCAHO standards automatically, rather than through manual chart review. For example, the present invention can be implemented in conjunction with the systems and methods discussed in U.S. patent application Ser. No. 10/287,054, filed Nov. 4, 2002 entitled “Patient Data Mining for Automated Compliance”, which is commonly assigned and incorporated herein by reference. U.S. Ser. No. 10/287,054 discloses a system and method for automatically generating performance measurement information for health care organizations. With such method, a user can access “on-line” the benchmarking service (131-7), for example, and formulate a query based on a specified performance measurement category. This query is then executed to obtain performance measurement information. The performance measurement information may be sent to a health care accreditation organization (such as JCAHO). The performance measurement information can include patient information from a health care provider being evaluated. For example, a health care accreditation organization may evaluate a hospital for its quality of care in treating heart attack patients. This patient information may include clinical information, financial information, and demographic information. The obtained performance measurement information may be sampled from a patient population. Alternatively, it may be obtained for an entire patient population.

Another example of services that can be implemented is automated correction of billing codes using the systems and methods described in U.S. patent application Ser. No. 10/727,197, filed on Dec. 3, 2003, entitled, “Systems and Methods For Automated Extraction and Processing of Billing Information in Patient Records”, which is commonly assigned and fully incorporated herein by reference. This application describes systems and methods for automatically extracting billing codes (e.g., ICD code) from structured and/or unstructured patient records, as well as extracting other billing information, for purposes of, e.g., generating, updating, and/or correcting medical claims.

External Marketing Consulting

Another possibility is to use structured information from healthcare providers to provide market intelligence for other companies. For example, in the system of FIG. 1, pharmaceutical companies could access an “on-line” service for external marketing consulting (131-8) to determine the potential market for a new drug, for example. Using this data, the size of a target population (e.g. diabetics who are not adequately controlling their blood sugar level today) could be readily measured based on the large collection of structured patient information maintained and/or accessible by the service provider. Other information that can be automatically determined is, e.g., which physicians are prescribing one particular drug versus another, and for what conditions are they prescribing one particular drug as compared to some competitive drug. For this purpose, the data could be divided by physician, by geographical location, or by any other measure.

Database-Guided Decision Support

Another useful application according to the invention, which can be developed based on a large collection of structured clinical information from different healthcare providers is database-guided decision support. Indeed, since data is being collected over a number of different healthcare provider groups, such information can be a significant knowledge base that can be searched to find similar cases to a current case under consideration. Such an approach could be useful in a variety of different settings, including diagnosis, prognosis, and treatment. In a diagnostic setting, the similar cases, along with their confirmed diagnosis, could be used to help assess a current case, and find possible diagnoses. In a prognostic setting, the similar cases could be used to estimate the prognosis for the patient in the current case. In a treatment setting, the similar cases, along with their outcomes, could help judge which treatment path may be best for this particular case.

More specifically, in one exemplary embodiment of the invention as depicted in FIG. 1, a user could access the database-guided decision support application (131-9) and access one of various functions associated with such application. For instance, in one embodiment, a method can be implemented to identify and display a list of patient cases that are similar to a current case based on the structured patient information that is available an accessible. In another embodiment, a method could be implemented to analyze a given patient case and generate a list of probable diagnoses, an estimated prognosis for the patient, and a list of treatments and their outcomes on similar cases. These methods could be implemented using machine learning methods to learn from the collected data. In another embodiment, information learned from the database could be provided for a particular case and present similar cases for a physician to analyze.

It is to be appreciated that the above applications are some exemplary commercial uses of structuring clinical data from healthcare providers. One of ordinary skill in the art could readily envision other applications. In general, all such applications are essentially based on methods that can collect legacy data, structure the legacy data, analyze the structured data, and report results of the analysis. In all instances, a key advantage is that clinical data from different healthcare providers can exploited for a number of different customers.

In one embodiment of the invention, for purposes of efficiency, the structuring of the data is performed using an automated method. However, in other embodiments of the invention, the analysis of the data could be completely automated, partially automated, or could even be manual. For example, consider the situation described above where the physician wishes to know which patients have an EF<30%, evidence of coronary artery disease, and no implanted defibrillator. In addition to a system for providing such information automatically, a system could list those patients with an EF<30% and no implantable defibrillator, along with structured information with respect to evidence of coronary artery disease, and have the physician or operator identify those patients with coronary artery disease. Alternatively, one could imaging a system where, for every patient, the ejection fraction, evidence of implantable defibrillator, and evidence of coronary artery disease is displayed (structuring method), and the user reviews such evidence to find those patients that match their criteria (analysis method).

Moreover, one of ordinary skill in the art could readily envision a variety of different business models that could be implemented. In one embodiment of a business model, various healthcare providers (e.g., physician groups, hospitals, . . . ) can offer their data to a service provider at no cost and in return, the service provider can provide the different healthcare providers access to the structured data, or some pre-defined services using the structured data (such as benchmarking services).

In another embodiment of a business model, various healthcare providers can offer their data to a service provider at no cost and in return, the service provider can provide the different healthcare providers limited access to the structured data, or some pre-defined base services using the structured data (such as benchmarking services). Healthcare providers are charged for additional access to data and additional.

In another embodiment of a business model, various healthcare providers can offer their data to a service provider at no cost. The service provider can then sell the data to pharmaceutical or device manufacturers for trial management in a HIPAA compliant way. In another embodiment of a business model, various healthcare providers can offer their data to a service provider at no cost and in return, the service healthcare provider and data providers jointly share in revenues associated with selling the data, for example, to pharmaceutical or device manufacturers for trials management in a HIPAA compliant way.

In another embodiment of a business model, various physician groups can offer their data to a service provider at no cost (or some fee), and the healthcare providers are then charged a transaction fee every time they access their data.

In another embodiment, a business model can be based on a per use market model, wherein paying customers can make proportional and/or periodic payments to the service provider based on the requested service(s). In this regard, there may be different types of “uses” that require different payment schedules. The manner in which a “use” is defined will vary depending on the business model and types of services offered by the service provider.

In another embodiment, various healthcare providers can offer their data to a service provider at no cost, the service providers provides access to data or parts of the data, at no cost and in return, the healthcare provider pays the service providers for each useful result. The payment can be based on revenue sharing, profit sharing, or a fee.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A business method for providing on-line healthcare management and decision support services, the method comprising:
a service provider maintaining a collection of structured clinical data, the structured clinical data comprising information automatically mined from various structured and unstructured sources of patient data from one or more different healthcare providers; and
the service provider providing a customer access to structured clinical data in the collection or providing a service to the customer using structured clinical data in the collection, the providing being based on a service agreement between the customer and the service provider.

2. The business method of claim 1, wherein maintaining a collection of structured clinical data comprises storing structured clinical data in a central repository that is managed by the service provider.

3. The business method of claim 1, wherein maintaining a collection of structured clinical data further comprises storing structured clinical data associated with a healthcare provider in a local repository of the healthcare provider.

4. The business method of claim 1, wherein the service provided to the customer comprises:
analyzing the collection of structured clinical data based on customer-specified inclusion and/or exclusion criteria to identify potential candidates for participation in a clinical trial; and
providing information to the customer regarding potential patients in a manner that maintains patient privacy.

5. The business method of claim 4, wherein the customer is a pharmaceutical company, a device manufacturer, or any other sponsor of a clinical trial.

6. The business method of claim 4, further comprising reporting information regarding the clinical trial and candidate lists to one or more healthcare providers having patients identified as potential candidates in the clinical trial.

7. The business method of claim 1, wherein providing a service to a customer comprises:
analyzing the collection of structured clinical data based on customer-specified inclusion and/or exclusion criteria to estimate a population size of potential patients for participation in a clinical trial; and
providing the customer with one or more estimates of population size based on different criteria formulations.

8. The business method of claim 1, wherein the service provided to the customer comprises providing disease management support for managing a chronic disease.

9. The business method of claim 8, wherein providing disease management support comprises;
analyzing the structured clinical data to obtain information related to treatment of one or more patients of the healthcare provider having the chronic disease; and
reporting the information to the customer.

10. The business method of claim 9, wherein the customer is a payer of healthcare, a third party disease management company, or the healthcare provider.

11. The business method of claim 1, wherein the service provided to the customer comprises providing physician or nurse support services to a healthcare provider.

12. The business method of claim 11, wherein providing physician or nurse support services comprises:
analyzing clinical data of the healthcare provider to assess a treatment path of a patient of the healthcare provider; and
reporting assessment result to the healthcare provider, the assessment results comprising an indication as to whether the treatment path complies with a clinical guideline or a suggestion as to one or more optimal treatment paths to follow.

13. The business method of claim 1, wherein the service provided to the customer comprises analyzing patient data of a healthcare provider to assist the healthcare provider to participate in or profit-from a performance-based pay program of a payer.

14. The business method of claim 13, wherein the assistance provided by the service provider comprises assessing one or more of adherence to clinical guidelines, patient outcomes, quality metrics, or total cost to manage a patient or combinations thereof.

15. The business method of claim 1, wherein the service provided to the customer comprises providing one or more healthcare provider management services.

16. The business method of claim 15, wherein providing one or more healthcare provider management services comprises analyzing structured clinical data to obtain information for generating a report about a patient, generating billing and financial information about a patient, generate a reminder or alert to assist in managing treatment of a patient, or any combination thereof.

17. The business method of claim 1, wherein the service provided to the customer comprises analyzing the collection of structured clinical data to perform benchmarking.

18. The business method of claim 1, wherein the service provided to the customer comprises analyzing the collection of structured clinical data for assessing the performance of one or more healthcare providers against a benchmark.

19. The business method of claim 18, wherein assessing the performance of one or more healthcare providers against the benchmark comprises determining compliance to standards established by accreditation agencies.

20. The business method of claim 19, wherein the customer is an accrediting agency.

21. The business method of claim 1, wherein the service provided to the customer comprises analyzing the collection of structured clinical data to assess a potential market for a drug or medical device.

22. The business method of claim 1, wherein providing a customer access to structured clinical data in the collection comprises:
searching the collection of structured clinical data based on specified search parameters to identify one or more cases that are similar to a current case based on the search parameters; and
presenting the one or more similar cases to the customer for review.

23. The business method of claim 1, wherein service agreement between the customer and the service provider is based on a business model where the customer is a healthcare provider that provides data to the service provider in exchange for the service provider allowing access to the collection of structured clinical data or one or more services.

24. The business method of claim 1, wherein the service agreement between the customer and the service provider is based on a business model where the customer is a healthcare provider that provides data to the service provider in exchange for a fee or for a portion of revenues or profits from selling the data of the healthcare provider to another customer.

25. The business method of claim 1, wherein service agreement between the customer and the service provider is based on a business model where the customer is charged for access to the structured clinical data.

26. The business method of claim 11, wherein providing physician support services comprises:
analyzing clinical data of the healthcare provider to assess patients eligible for treatment under a newly adopted guideline; and
reporting assessment results to the healthcare provider, the assessment results comprising the patients and supporting evidence for their eligibility for treatment under the guideline.

27. The business method of claim 26 where the revenues of the suggested treatment are shared between the healthcare provider and the service provider.

28. The business method of claim 26 where the profits of the suggested treatment are shared between the healthcare provider and the service provider.

29. The business method of claim 26 where the healthcare provider is charged per suggestion made by the service provider.

30. The business method of claim 6, wherein the customer is a pharmaceutical company, a device manufacturer, or any other sponsor of a clinical trial.

31. The business method of claim 7 further comprising updating the criteria.

32. The business method of claim 8 wherein providing disease management support comprises identifying patients eligible for patient management services.

33. The business method of claim 12 wherein the indication is the suggestion made at the point of care.

34. The business method of claim 12 where revenues from the suggestion are shared between the healthcare provider and the service provider.

35. The business method of claim 12 where profits from the suggestion are shared between the healthcare provider and the service provider.

36. The business method of claim 12 where the healthcare provider is charged per suggestion made by the service provider.

37. The business method of claim 1, wherein the service provided to the customer comprises providing decision support for preventive care.

38. The business method of claim 37, wherein providing decision support for preventive care comprises;
analyzing the structured clinical data to obtain information related to preventive care of one or more patients of the healthcare provider; and
reporting the information to the customer.

39. The business method of claim 9, wherein the customer is a payer of healthcare, a third party disease management company, or the healthcare provider.

40. The business method of claim 13 where an increase in revenues or profits due to the performance-based pay program is shared by the healthcare provider and the service provider.

41. The business method of claim 16, where the healthcare provider management services are provided at the point of care.

42. The business method of claim 7 further comprising:
charging the customer for providing the one or more estimates.

43. The business method of claim 7 further comprising:
determining whether the criteria are to broad or to narrow as a function of the population size.

44. The business method of claim 11 wherein the service is provided at no cost.

45. The business method of claim 11 wherein the service is provided for a fee.

46. The business method of claim 1 wherein the service provider provides the customer on-line access to the structured clinical data in the collection.

47. The business method of claim 1 wherein the service provider provides the service on-line to the customer using structured clinical data in the collection.

48. The business method of claim 1 wherein the service provider provides corrected information for the sources of patient data.
